(19) United States
(12) Patent Application Publication
(10) Pub. No.: US 2009/0000586 A1
(43) Pub. Date: Jan. 1, 2009

(54) Air Intake System

(76) Inventor: David Tonery, London (GB)

Correspondence Address: DYKAS, SHAVER & NIPPER, LLP, P.O. BOX 877, BOISE, ID, 83701-0877, US

(21) Appl. No.: 12/067,484

(22) PCT Filed: Sep. 19, 2006
(86) PCT No.: PCT/GB2006/003482

§ 371 Date: Aug. 8, 2008

(30) Foreign Application Priority Data
Sep. 23, 2005 (GB) 0519402.2

(51) Int. Cl. F02M 35/104

(52) U.S. Cl. 123/184.47; 55/290

(57) ABSTRACT

An air intake system for a combustion apparatus is described. The system comprises an air separator (16, 116, 216, 316) having an inlet for receiving air and an outlet, the outlet adapted to be coupled to an air intake of a combustion apparatus, wherein the air separator comprises a zeolite material adapted to absorb a portion of nitrogen from air received therein. In one embodiment the combustion apparatus is an internal combustion engine (14, 114, 214, 314).

### FIELD OF THE INVENTION

The present invention relates to an air intake system for a combustion apparatus, such as an internal combustion engine, and in particular to a system for removing nitrogen from air prior to being directed towards a combustion apparatus.

### BACKGROUND TO THE INVENTION

There are considerable environmental concerns over the increasing use of fossil fuels, and efforts are being made to reduce harmful emissions from, for example, internal combustion engines, while seeking to maximise fuel efficiency and engine performance. In the automotive industry developments are ongoing to seek to improve the quality of exhaust gases emitted from vehicles by reducing the percentage content of environmental toxins, such as unburned hydrocarbons, carbon monoxide, oxides of nitrogen and the like. For example, developments in catalyst materials and engine management systems seek to lower such emissions. However, it is often the case that efforts to reduce emissions from internal combustion engines adversely affects engine performance, and result in significant cost increases.

It is an object of the present invention to provide a system which seeks to obviate or mitigate these and other problems in the prior art.

### SUMMARY OF THE INVENTION

According to a first aspect of the present invention, there is provided an air intake system for a combustion apparatus, said system comprising an air separator having an inlet for receiving air and an outlet, said outlet adapted to be coupled to an air intake of a combustion apparatus, wherein the air separator comprises a zeolite material adapted to absorb a portion of nitrogen from air received therein.

Accordingly, in use, a substantial portion of nitrogen may be removed from air by the zeolite material, producing a stream of treated air with a high oxygen concentration to be directed to the air intake of the combustion apparatus. This arrangement favourably permits more complete or near stoichiometric combustion of fuel within the combustion apparatus, which in some applications may boost efficiency and performance, decrease fuel consumption, and reduce the volume of carbon monoxide produced. Furthermore, by significantly reducing the level of nitrogen within the intake air fed into the combustion apparatus, the level of nitrogen oxides produced is also reduced.

Preferably, the air intake system is for use with a combustion apparatus comprising an engine, wherein the outlet of the air intake system is adapted to be coupled to an air intake of said engine. The engine may be an internal combustion engine, such as a piston engine, rotary engine, gas turbine engine, for example for use in aircraft or for driving a generator for electricity production, or the like. Alternatively, the engine may be a homogeneous charge compression ignition engine.

Alternatively, the combustion apparatus may comprise a furnace or the like, such as a furnace for heating water to produce steam, heating air, for use in smelting or refining ores, incinerating, or the like.

Advantageously, the combustion apparatus may utilise any combustible fuel, such as hydrocarbon based fuels or the like.

Preferably, the air separator comprises a canister incorporating the zeolite material, wherein the canister defines a fluid inlet for receiving air and a first fluid outlet for discharging treated air therefrom. Advantageously, the canister is configured to be exposed to a pressure differential between the fluid inlet and first fluid outlet for driving air through the canister. Beneficially, the zeolite material is adapted to absorb nitrogen from air received within the canister when said canister is exposed to the pressure differential. Advantageously, the canister may be configured to be exposed to a positive pressure differential; that is, the air may be caused to be driven through the canister at a pressure greater than atmospheric. Alternatively, the canister may be configured to be exposed to a negative pressure differential such that air is caused to be pulled through the canister at a pressure less than atmospheric; that is, the canister may be exposed to a vacuum. For purposes of clarity, it should be noted that the air may be defined as “pressurised” when either a positive or negative pressure differential is utilised. It should also be noted that references herein to pressurising the air separator or any component thereof, such as the canister, implies charging said air separator with pressurised air (that is, air which is above or below atmospheric pressure).

Preferably, the air intake system further comprises pressurising means for delivering pressurised air through the air separator. In one embodiment of the present invention the pressurising means may be positioned upstream of the air separator and coupled to the fluid inlet thereof. In this arrangement, air may be delivered through the air separator by a positive pressure differential. In an alternative embodiment, the pressurising means may be positioned downstream of the air separator and coupled to the outlet thereof such that this arrangement causes air to be pulled through the air separator by creating a negative pressure differential.

In a further alternative embodiment, the pressurising means may form part of the air separator. For example, the pressurising means may form an integral part of the air separator. In one arrangement, the pressurising means may comprise at least one operational component incorporating a zeolite material for use in absorbing nitrogen from air. This arrangement advantageously reduces the number of separate components within the air intake system as the air separator and pressurising means may be incorporated in a single unit.

Preferably, the pressurising means may be adapted to deliver pressurised or compressed air into the air intake of the combustion apparatus after said air has been treated by the air separator. Alternatively, separate pressurising means may be provided for delivering compressed air into the combustion apparatus. Delivering compressed air into the combustion apparatus provides a means of forced air induction to permit the apparatus to operate effectively and to maximise performance. Beneficially, the pressurising means may be adapted to provide an air compression ratio of between, for example, 5:1 and 12:1.

Advantageously, the pressurising means may comprise a compressor. In one embodiment the pressurising means comprises a supercharger unit. The supercharger unit may be of a roots-type, centrifugal-type or the like. Preferably, the supercharger unit is of a screw-type.

The supercharger unit may be adapted to be driven directly from the combustion apparatus, such as an engine, for example via a fan belt or fan belt extension. Alternatively, the supercharger may advantageously be driven by separate drive means, such as by an electric motor or the like. This arrangement permits operation and control of the supercharger independently from, for example, the engine speed, providing more accurate and controlled air compression when required.

In one embodiment, the supercharger may comprise a zeolite material adapted to absorb nitrogen from air being compressed therein. For example, compressing elements, such as compressor blades or intermeshing screws or the like, may be formed, at least partially, of a zeolite material, such that in use the nitrogen within the air being compressed may be absorbed thus producing a stream of high pressure air with a high oxygen concentration.

In an alternative embodiment, the pressurising means may comprise a turbocharger adapted to be driven by exhaust gases produced by the combustion apparatus when in operation. In one arrangement, at least a portion of the turbocharger may incorporate a zeolite material.

Advantageously, the air intake system may comprise means for cooling air prior to being directed towards the combustion apparatus. In a preferred embodiment, air cooling means may be positioned downstream of the air separator and coupled to the outlet thereof. Most preferably, the air cooling means is positioned downstream of both the air separator and pressurising means such that said air cooling means, in use, operates to cool compressed air with a high oxygen concentration. Accordingly, the air cooling means operates to cool air which has been heated by being compressed by the pressurising means, thus increasing the density of said air prior to being directed to the intake of the combustion apparatus. In an alternative embodiment, the air cooling means may be positioned upstream of the air separator.

Advantageously, the air cooling means may comprise an intercooler, such as an air-to-air intercooler or an air-to-liquid intercooler.

Preferably, the air intake system further comprises means for cyclically pressurising and depressurising the air separator, specifically the canister containing the zeolite material. In use, pressurising the air separator will permit the zeolite material to absorb nitrogen from air, whereas depressurising the air separator will permit the zeolite material to release adsorbed nitrogen and thus regenerate in preparation to repeat the cycle. Preferably, the air separator is depressurised by venting the canister to atmosphere to thus dispose of the absorbed nitrogen. Advantageously, the canister may define a second fluid outlet for venting the canister to atmosphere to thus depressurise said canister and allow the zeolite material to regenerate. Preferably also, the air separator is pressurised by increasing the pressure above atmospheric, or alternatively reducing the pressure below atmospheric.

Preferably, the air intake system comprises valve means for use in cyclically pressurising and depressurising the air separator. Advantageously, the valve means may be adapted to cyclically open and close the canister to atmosphere, for example via the second fluid outlet. Advantageously also, the valve means may be adapted to cyclically isolate the air separator from a supply of air. Preferably, the arrangement is such that the valve means opens the canister to atmosphere via the second fluid outlet while isolating the canister from an air supply, and following this closes the canister from atmosphere and permits communication with an air supply. Accordingly, this arrangement permits the air intake system to continuously operate to provide a supply of air with a high oxygen concentration for use in the combustion apparatus.

The valve means may comprise one or more pinch valves, solenoid valves, butterfly valves or the like, or any combination thereof.

Advantageously, the air intake system may further comprise control means adapted to operate the valve means. The control means may incorporate a switching system, such as a relay system or the like. Alternatively, or additionally, the control means may incorporate a programmable controller.

In a preferred embodiment, the air intake system comprises an oxygen sensor, preferably positioned downstream of the air separator. Advantageously, the oxygen sensor may be adapted to detect the level of oxygen in the air discharged from the outlet of the air separator. Beneficially, the oxygen sensor is in communication with the valve means such that said valve means may be controlled to pressurise and depressurise the air separator in accordance with the level of oxygen in the air discharged therefrom. Accordingly, in a preferred use, the valve means may be operated to depressurise the air separator to permit the zeolite material therein to regenerate when the level of oxygen is detected by the oxygen sensor to have fallen below a predetermined quantity. Advantageously, the oxygen sensor may be in communication with the valve means via a suitable control means.

In a preferred embodiment of the present invention, the air separator comprises at least two canisters, each incorporating a zeolite material. Preferably, each canister defines a fluid inlet for receiving air and a first fluid outlet for venting air towards the intake of the combustion apparatus. Preferably also, each canister defines a second fluid outlet for venting each canister to atmosphere to thus depressurise said canisters and allow the zeolite material therein to regenerate.

Advantageously, in use one of the at least two canisters is adapted to be pressurised to permit the zeolite material therein to adsorb nitrogen from air, while another of the at least two canisters is adapted to be depressurised to permit the zeolite contained therein to release adsorbed nitrogen.

Beneficially, the valve means is adapted to selectively pressurise and depressurise alternate canisters. For example, the valve means may permit one canister to be pressurised while permitting another canister to be depressurised. Beneficially, this arrangement permits the zeolite material within one canister to absorb nitrogen from air while the zeolite material within another canister is regenerated by releasing nitrogen adsorbed therein. In this way, a substantially continuous operation may be achieved for continuously supplying air with a high oxygen concentration to the intake of the combustion apparatus.

Preferably, the air intake system further comprises an air filter, preferably adapted to filter particulate material from air to be supplied to the intake of the combustion apparatus. In a preferred embodiment of the present invention, the air filter is positioned upstream of the air separator, thus eliminating or at least minimising fouling of the zeolite material therein. Alternatively, the air filter may be positioned downstream of the air separator.

Advantageously, the air intake system is adapted for use with one or both of petrol and diesel engines. Advantageously also, the air intake system is adapted for use with fuel injection-type engines. Beneficially, in this arrangement the injection of fuel into the engine may be monitored and controlled to accommodate the specific air quality output from the air separator. Advantageously, the fuel injection system of the engine may be controlled by control means associated with the air intake system.

The air intake system of the present invention may comprise natural zeolite material or alternatively may comprise synthesised zeolite material.

According to a second aspect of the present invention, there is provided a combustion apparatus having an air intake system comprising an air separator having an inlet for receiving air and an outlet coupled to an air intake of the combustion apparatus, wherein the air separator comprises a zeolite material adapted to absorb a portion of nitrogen from air received therein.

The combustion apparatus may comprise an internal combustion engine, a furnace or the like.

Preferably, the air intake system is the air intake system according to the first aspect.

According to a third aspect of the present invention, there is provided a compressor comprising a zeolite material adapted to absorb nitrogen from a fluid when said fluid is compressed by said compressor.

Preferably, the compressor comprises compressing elements at least partially formed of a zeolite material. In one embodiment, the compressor is a screw compressor comprising a pair of screw compressing elements, wherein at least a portion of one screw element is formed of a zeolite material. In an alternative embodiment, the compressor may be a centrifugal compressor, scroll compressor, piston compressor or the like.

Advantageously, the compressor according to the third aspect therefore provides, in use, a stream of compressed fluid from which nitrogen has been substantially eliminated.

Advantageously, the compressor may be a supercharger, turbocharger or the like, adapted to compress air to be directed into a combustion apparatus, such as an internal combustion engine.

### BRIEF DESCRIPTION OF THE DRAWINGS

These and other aspects of the present invention will now be described, by way of example only, with reference to the accompanying drawings, in which:

FIG. 1 is a diagrammatic representation of an air intake system in accordance with one embodiment of the present invention;

FIG. 2 is a diagrammatic representation of an air intake system in accordance with an alternative embodiment of the present invention;

FIG. 3 is a diagrammatic representation of an air intake system in accordance with another alternative embodiment of the present invention;

FIG. 4 is a diagrammatic representation of an air intake system in accordance with a still further alternative embodiment of the present invention;

FIG. 5 is a diagrammatic representation of an air intake system in accordance with another embodiment of the present invention;

FIG. 6 is a diagrammatic view of a compressor arrangement, forming part of the air intake system of FIG. 5, in accordance with an embodiment of the present invention;

FIG. 7 is a diagrammatic representation of an air intake system in accordance with a further embodiment of the present invention; and

FIG. 8 is a diagrammatic view of a compressor arrangement, forming part of the air intake system of FIG. 7, in accordance with an embodiment of the present invention.

### DETAILED DESCRIPTION OF THE DRAWINGS

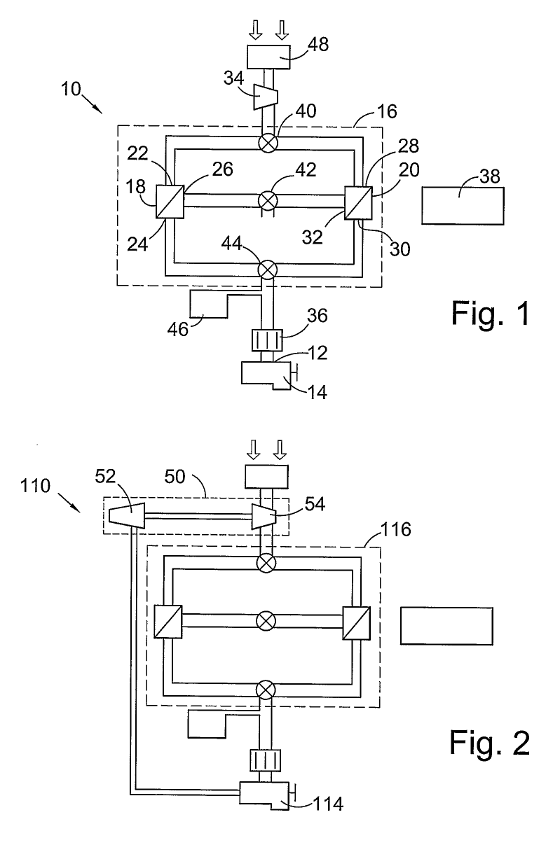

Reference is first made to FIG. 1 of the drawings in which there is shown a diagrammatic representation of an air intake system in accordance with one embodiment of the present invention. The air intake system, generally identified by reference numeral 10, is for use in treating air prior to being supplied to the air intake 12 of an internal combustion engine 14. The engine 14 may be a static engine, for example for driving a generator or the like, or alternatively may be for use in a vehicle or the like.

The air intake system 10 incorporates an air separator 16, shown in broken outline, which, as will be discussed in detail below, includes a zeolite material for use in absorbing nitrogen from air prior to being discharged towards the engine 14. Accordingly, in use, a substantial portion of nitrogen may be removed from air by the zeolite material, producing a stream of treated air with a high oxygen concentration to be directed to the air intake 12 of the engine 14. This arrangement favourably permits more complete or near stoichiometric combustion of fuel within the engine 14, boosting engine efficiency and performance, decreasing fuel consumption, and reducing the volume of carbon monoxide produced. Furthermore, by significantly reducing the level of nitrogen within the intake air fed into the engine, the level of nitrogen oxides produced is also reduced.

In the embodiment shown, the air separator 16 comprises two canisters 18, 20 each of which contains a zeolite material. The first canister 18 defines a fluid inlet 22, a first fluid outlet 24 and a second fluid outlet 26. Similarly, the second canister 20 also defines a fluid inlet 28, a first fluid outlet 30 and a second fluid outlet 32. In use, air may be directed into each canister 18, 20 via respective fluid inlets 22, 28, and treated air may then be discharged from each canister 18, 20 via respective first fluid outlets 24, 30 and subsequently towards the intake 12 of the engine 14. Nitrogen absorbed by the zeolite material within the canisters 18, 20 may be released via the respective second fluid outlets 26, 32, as will be discussed in further detail below.

The air intake system 10 further comprises a supercharger unit 34 which is positioned upstream of the air separator 16. Although not shown, the supercharger 34 may be directly driven by an electric motor operated by the engine's electrical system, or alternatively may be driven via a fan belt or the like. In use, the supercharger 34 compresses air to be driven through the air separator 16 by a positive pressure differential. Accordingly, the air is caused to be forced through each canister 18, 20 under pressure such that the zeolite material may absorb nitrogen when the air is in a pressurised state. In use, the supercharger 34 and air separator 16 provide a stream of compressed air having a high oxygen concentration to be supplied to the engine 14.

The system 10 also incorporates an intercooler unit 36 positioned downstream of the air separator 26. This arrangement is favourable in that the air, which has been heated during compression in the supercharger 34 and thus has a reduced density, is cooled to increase the air density and thus provide a more dense volume of air for use by the engine. Although not shown in detail, the intercooler 36 may be of an air-to-air type or alternatively an air-to-liquid type, which are known in the art.

The intake system 10 in the embodiment shown also comprises a control system which in use permits the air separator 16 to function to provide a substantially constant flow of treated air of the required quality, as discussed below. The control system comprises a controller, such as a programmable microcontroller, represented graphically by reference numeral 38, a valve arrangement incorporating three separate three-way valves 40, 42, 44, and an oxygen sensor 46 positioned downstream of the separator 16. In use, valve 40 is initially configured to permit compressed air from the supercharger 34 to flow into the first canister 18 via fluid inlet 22, while preventing air from flowing towards the second canister 20. Valve 44 is configured to permit compressed and treated air to be discharged from the first fluid outlet 24 of the first canister 18 towards the engine 14 while preventing fluid communication between the second canister 20 and the engine 14. Valve 42 is configured to close the second fluid outlet 26 of the first canister 18 while opening the second fluid outlet 32 of the second canister 20 to thus vent the second canister 20 to atmosphere.

During operation of the system 10 with the valves positioned as noted above, the oxygen sensor 46 continuously monitors the oxygen content within the air discharged from the separator 16 towards the engine 14. When the oxygen level is detected to fall below a predetermined minimum level, indicating that the zeolite material within the first canister 18 is becoming saturated with nitrogen, the controller 38 generates a signal to cause the valves 40, 42, 44 to reconfigure as follows: valve 40 is reconfigured to permit compressed air from the supercharger 34 to flow towards the second canister 20 while preventing the flow of air towards the first canister 18; valve 44 is reconfigured to permit treated air from the first fluid outlet 30 of the second canister 20 to flow towards the engine 14 while preventing fluid communication between the first canister 18 and the engine 14; and valve 42 is reconfigured to close the second fluid outlet 32 of the second canister 20 while opening the second fluid outlet 26 of the first canister 18 and thus expose the first canister 18 to atmosphere. Accordingly, by exposing the first canister 18 to atmosphere, said canister is caused to be depressurised permitting the zeolite material contained therein to release absorbed nitrogen and thus regenerate, while the second canister 20 functions to continue to supply high oxygen concentration compressed air towards the engine 14.

Once the oxygen level is again sensed to have dropped below the minimum level, the valves 40, 42, 44 may again be reconfigured to maintain operation. It should be noted that the operation of the air separator 10 in the embodiment shown in FIG. 1 may be termed “pressure swing absorption”, in that the air is forced through each canister cyclically by a positive pressure differential.

The system 10 further comprises an air filter 48 located upstream of the air separator 16 in order to remove particulate material from air prior to being compressed by the supercharger 34 and directed towards the separator 16 to thus prevent or at least minimise fouling of the zeolite material contained therein.

Reference is now made to FIG. 2 in which there is shown an air intake system, generally indicated by reference numeral 110, in accordance with an alternative embodiment of the present invention. The system 110 of FIG. 2 is similar to the system 10 in FIG. 1, and as such like features share like reference numerals, incremented by 100. For the purposes of brevity, only the differences between the two systems 10, 110 will be identified herein. The only significant difference is that the supercharger unit 34 of the system 10 of FIG. 1 has been replaced in the system 110 of FIG. 2 with a turbocharger unit, shown in broken outline and identified by numeral 50. The turbocharger 50 is of conventional design and incorporates a turbine 52 adapted to be driven by exhaust gases from the engine 114, wherein the turbine drives an air compressor 54 for compressing air prior to entering the air separator 116.

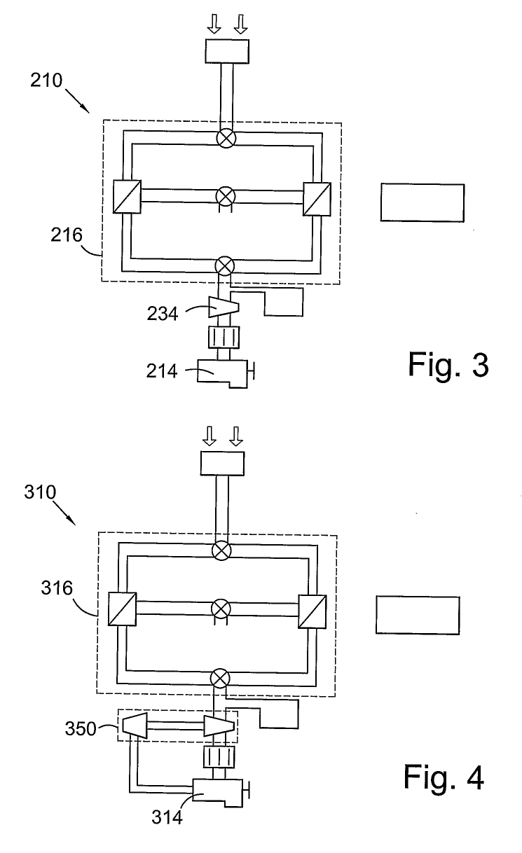

A further alternative embodiment of an air intake system for use with an internal combustion engine is shown in FIG. 3. The system, generally identified by reference numeral 210, is similar to that shown in FIG. 1 except that the supercharger 234 is located downstream of the air separator 216 and thus provides a negative pressure differential to pull air therethrough.

Another embodiment of an air intake system, in this case identified by numeral 310, is shown in FIG. 4. The system 310 is similar to that system 110 shown in FIG. 2 with the exception that a turbocharger 350 is positioned downstream of the air separator 316.

In both systems 210, 310 shown in FIGS. 3 and 4 respectively, the air separators 216, 316 may be considered to operate by “vacuum swing absorption” in that the air is caused to flow through the air separators 216, 316 by a negative pressure differential.

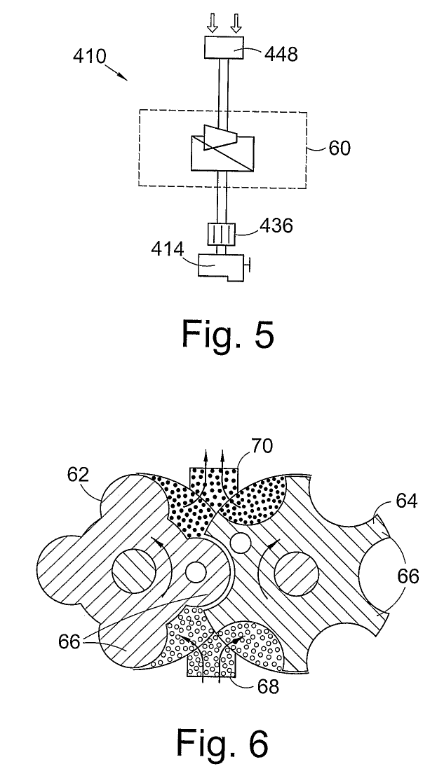

Reference is now made to FIG. 5 of the drawings in which there is shown, diagrammatically, an air intake system in accordance with an alternative embodiment of the present invention. The air intake system, generally identified by reference numeral 410, comprises an air separator and supercharger which are integrally formed in a single unit 60. The combined air separator and supercharger unit 60 is diagrammatically shown in FIG. 6, reference to which is now additionally made. The unit 60 incorporates a screw-type supercharger which comprises first and second screw components 62, 64 having intermeshing lobes 66, each of which screw components 62, 64 are formed of a zeolite material adapted to absorb nitrogen from compressed air. The supercharger operates in a conventional manner such that counter rotation of the screw components 62, 64 cause air to be drawn into the supercharger via an inlet 68, compressed between the intermeshing lobes 66, and discharged through an outlet 70 at an increased pressure. Nitrogen within the air being compressed is thus absorbed by the zeolite material forming the screws 62, 64. During rotation, the portion of the screws 62, 64 which are not exposed to compressed air may thus release absorbed nitrogen and therefore regenerate.

As shown in FIG. 5, the system 410 also comprises an air filter 448 located upstream of the unit 60, and an intercooler 436 located downstream of the unit 60.

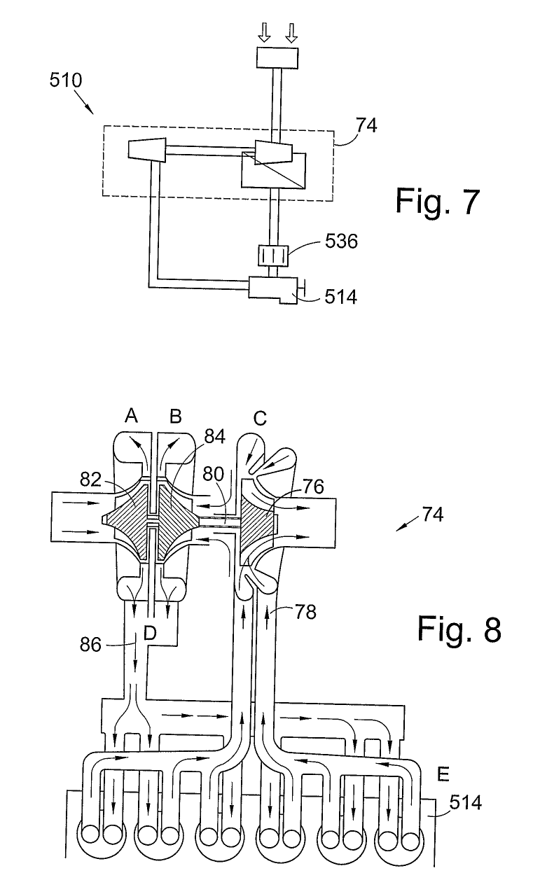

A further embodiment of an air intake system according to the present invention is shown diagrammatically in FIG. 7. The system, generally identified by reference numeral 510, is similar to that shown in FIG. 5 with the exception that the combined air separator and supercharger unit 60 (FIG. 5) is replaced by a combined air separator and turbocharger unit 74 which is driven by the exhaust gases from the engine 514. Unit 74 is shown diagrammatically in FIG. 8, reference to which is now made.

The turbocharger within the unit 74 comprises a turbine 76 driven by exhaust gases 78 discharged from the engine 514, wherein the turbine 76 is rotatably coupled via a shaft 80 to two compressor impellers 82, 84 which in use operate to compress air. The impellers 82, 84 are formed, at least partially, from a zeolite material adapted to absorb nitrogen from compressed air. A three-way valve 86 is provided between the compressors 82, 84 and the engine 514. It should be noted that the intercooler 536 (FIG. 7) has been omitted from FIG. 8 for the purposes of clarity. Valve 86 is adapted to provide alternate fluid communication between each impeller 82, 84 and the engine 514 such that in normal operation a single impeller provides compressed air to the engine 514 at any one time.

Each compressor impeller 82, 84 comprises an associated waste-gate (not shown) for venting compressed air to atmosphere.

In use, the turbine 76 drives each impeller 82, 84, and the valve 86 is configured to permit compressed air from impeller 82 only to be directed towards the engine 514, while the waste-gate associated with impeller 84 is opened to atmosphere. When the level of oxygen within the compressed air being supplied to the engine 514 drops below a predetermined level, the valve 86 may then be reconfigured to permit impeller 84 only to supply compressed air to the engine 514. At this stage the waste-gate associated with impeller 82 may be opened to vent to atmosphere such that nitrogen absorbed by the zeolite material forming impeller 82 may be released, thus regenerating the zeolite material. The cycle may then be repeated to provide a continuous stream of compressed air with a high oxygen concentration.

It should be understood that the embodiments described herein are exemplary and that modifications may be made thereto without departing from the scope of the invention. For example, the system may not require the use of a compressor, such as a supercharger or turbocharger, and may rely on the negative pressure differential generated by the engine when in use. Additionally, the oxygen sensor may be replaced by a timer mechanism or device which cycles the system based on set time intervals. It may be preferred in some embodiments to eliminate the intercooler. Furthermore, more than two canisters containing zeolite material may be utilised.

Additionally, the air intake system may be used in combination with other engine types, such as a rotary engine or a gas turbine engine or the like. Furthermore, the air intake system may be utilised with other forms of combustion apparatus such as furnaces or the like.

1. A homogeneous charge compression ignition combustion apparatus comprising an air intake system, said system comprising an air separator having an inlet for receiving air and an outlet, said outlet adapted to be coupled to an air intake of the combustion apparatus, wherein the air separator comprises a zeolite material adapted to absorb a portion of nitrogen from air received therein.

2. The combustion apparatus of claim 1, comprising an engine, wherein the outlet of the air intake system is adapted to be coupled to an air intake of said engine.

3. (canceled)

4. (canceled)

5. The combustion apparatus of claim 1, wherein the air separator comprises a canister incorporating the zeolite material, wherein the canister defines a fluid inlet for receiving air and a first fluid outlet for discharging treated air therefrom.

6. The combustion apparatus of claim 5, wherein the canister is configured to be exposed to a pressure differential between the fluid inlet and first fluid outlet for driving air through the canister.

7. The combustion apparatus of claim 6, wherein the zeolite material is adapted to absorb nitrogen from air received within the canister when said canister is exposed to the pressure differential.

8. The combustion apparatus of claim 6, wherein the canister is configured to be exposed to a positive pressure differential.

9. The air intake system of claim 6, wherein the canister is configured to be exposed to a negative pressure differential.

10. The combustion apparatus of claim 1, further comprising a compressor for delivering pressurised air through the air separator.

11. The combustion apparatus of claim 10, wherein the compressor is positioned upstream of the air separator and coupled to the fluid inlet thereof.

12. The combustion apparatus of claim 10, wherein the compressor is positioned downstream of the air separator and coupled to the outlet thereof.

13. The combustion apparatus of claim 10, wherein the compressor forms part of the air separator.

14. The combustion apparatus of claim 13, wherein the compressor comprises at least one operational component incorporating a zeolite material for use in absorbing nitrogen from air.

15. The combustion apparatus of claim 10, wherein the compressor is adapted to deliver pressurised air into the air intake of the combustion apparatus after said air has been treated by the air separator.

16. (canceled)

17. The combustion apparatus of claim 10, wherein the pressurizing means compressor comprises a supercharger unit.

18. The combustion apparatus of claim 17, wherein the supercharger comprises a zeolite material adapted to absorb nitrogen from air being compressed therein.

19. The combustion apparatus of claim 10, wherein the compressor comprises a turbocharger.

20. The combustion apparatus of claim 19, wherein at least a portion of the turbocharger incorporates a zeolite material.

21. The combustion apparatus of claim 1, further comprising an air cooler.

22. The combustion apparatus of claim 21, wherein the air cooler is positioned downstream of the air separator and coupled to the outlet thereof.

23. The combustion apparatus of claim 21, wherein the air cooler comprises an intercooler.

24. The combustion apparatus of claim 1, further comprising means for cyclically pressurising and depressurising the air separator.

25. The combustion apparatus of claim 24, wherein the air separator comprises a canister incorporating the zeolite material, wherein the canister defines a fluid inlet for receiving air and a first fluid outlet for discharging treated air therefrom, and wherein the air separator is depressurised by venting the canister to atmosphere.

26. The combustion apparatus of claim 25, wherein the canister defines a second fluid outlet for venting the canister to atmosphere.

27. The air intake system of claim 24, comprising a valve for use in cyclically pressurising and depressurising the air separator.

28. The combustion apparatus of claim 27, further comprising a controller adapted to operate the valve.

29. The combustion apparatus of claim 1, further comprising an oxygen sensor positioned downstream of the air separator.

30. The combustion apparatus of claim 29, further comprising a valve for use in cyclically pressurising and depressurising the air separator, wherein the oxygen sensor is in communication with the valve such that said valve may be controlled to pressurise and depressurise the air separator in accordance with the level of oxygen in the air discharged therefrom.

31. The combustion apparatus of claim 1, wherein the air separator comprises at least two canisters, each incorporating a zeolite material.

32. The combustion apparatus of claim 31, wherein each canister defines a fluid inlet for receiving air and a first fluid outlet for venting air towards the intake of the combustion apparatus.

33. The combustion apparatus of claim 32, wherein each canister defines a second fluid outlet for venting each canister to atmosphere.

34. The combustion apparatus of claim 31, wherein, in use, one of the at least two canisters is adapted to be pressurised to permit the zeolite material therein to adsorb nitrogen from air, while another of the at least two canisters is adapted to be depressurised to permit the zeolite contained therein to release adsorbed nitrogen.

35. The combustion apparatus of claim 1, further comprising an air filter.

36. The combustion apparatus of claim 35, wherein the air filter is positioned upstream of the air separator.

37. (canceled)

38. A compressor comprising a zeolite material adapted to absorb nitrogen from a fluid when said fluid is compressed by said compressor.

39. The compressor of claim 38, comprising compressing elements at least partially formed of a zeolite material.

40. The compressor of claim 39, wherein the compressor is a screw compressor comprising a pair of screw compressing elements, wherein at least a portion of one screw element is formed of a zeolite material.

41. The compressor of claim 38, wherein the compressor is adapted to compress air to be directed into a combustion apparatus.

42. The compressor of claim 38, wherein the compressor is adapted to compress air to be directed into a homogeneous charge compression ignition combustion apparatus.

43. A homogeneous charge compression ignition combustion apparatus comprising an air intake system, said system comprising an air separator having an inlet for receiving air and an outlet, said outlet adapted to be coupled to an air intake of the combustion apparatus, wherein the air separator is adapted to absorb a portion of nitrogen from air received therein, and to communicate air with an increased concentration of oxygen to the combustion apparatus.

44. The combustion apparatus of claim 1, wherein the air separator is adapted to communicate air with an increased concentration of oxygen to the combustion apparatus.
